(19) United States
(12) Patent Application Publication
(10) Pub. No.: US 2008/0318198 A1
(43) Pub. Date: Dec. 25, 2008

(54) System and method for draft selection and participation therein

(76) Inventor: John H. Walters, Townsend, MA (US)

Correspondence Address: MILES & STOCKBRIDGE PC, 1751 PINNACLE DRIVE, SUITE 500, MCLEAN, VA, 22102-3833, US

(21) Appl. No.: 12/213,667

(22) Filed: Jun. 23, 2008

Related U.S. Application Data
(60) Provisional application No. 60/945,462, filed on Jun. 21, 2007.

(51) Int. Cl. G09B 3/00

(52) U.S. Cl. 434/322

(57) ABSTRACT

A fan-based draft is disclosed whereby fans select an 8^{th} round draft choice pursuant to a pre-designated voting structure within a reality show format. Fans select players from an eligible pool. NFL teams draft an 8^{th} round choice based on fan selection. The player participates in the team's pre-season training. The player receives an incentive such as a signing bonus. The incentive is paid by the show and/or sponsor(s). Team expenses related to pre-season training are also paid by the show and/or sponsor(s). The player is eligible for a space on the team roster and/or a long-term contract; however the team is not required to provide either. A portion of profits earned are invested into a retired player's fund.

### FIELD OF THE INVENTION

The present invention relates to a system and method for draft selection, specifically a means for fan participation and a means for financing a financial safety net for retired players.

### THE INVENTION

In accordance with one or more embodiments of the present invention, the provided examples refer to the National Football League (NFL). However, it is contemplated that the system and method disclosed herein could be used with a variety of groups and a range of circumstances. For example, the system and method may also be used with, but not limited to, Major League Baseball (MLB), the National Hockey League (NHL), the National Basketball Association (NBA), etc.

In practice, one or more sponsors selects a format structure. Such structure can comprise participation in a financial vehicle established by sponsor. Such participation can include buying, reviewing or sampling sponsor's product. Alternatively, such structure can comprise a contest, rebate or call request to vote.

Fans participate pursuant to format guidelines. It is contemplated that fans can vote at sponsors' facility, by coupon, on sponsor's web site, by cell phone, or by way of others means as would be known by one of ordinary skill in the art.

Fans select a draft choice from an eligible pool. In a first embodiment eligible pool shall comprise undrafted free agents (UDFA) Group 2. Every team loses players each year through retirement, injury, trades, or defection at contract conclusion. Thus, the team roster must be replenished each year. Only about eight percent of eligible players are formally drafted in the seven round session (Official NFL Draft) by each of the 32 NFL teams. These sessions generally occur in April, and last two days (time is allotted per each pick to field trades or reconsider alternative choices). About 224 players get drafted each year. Each team may also be eligible for certain compensatory added draft choices. These are awarded by the NFL to teams that lose a top tier player in the previous season to other teams, when they cannot reach contractual agreements with those players. Teams may draft players that are not a participant in the formal seven-round session. These players may come from smaller schools or may have experienced injury that precluded their participation in the seven-round draft. Approximately five to seven percent of players are bid for and signed as undrafted free agents (UDFA). Teams approach UDFA player's agents and make offers for services and for try-outs. There is no draft order. This is open bid. This group is referred to herein as UDFA Group 1.

As referred to herein, UDFA Group 2 shall refer to the remaining 87 percent of eligible players not formally drafted. To be eligible, a player must be of a certain age and must apply and enter the Official NFL Draft of that specific year by contacting the NFL. Eligible players are preferably College Seniors. Although, inclusion of younger and older players is contemplated. There are about 2,500 eligible college players every year. In an alternative embodiment, the eligible pool shall comprise those players invited to the NFL Combine. This number is approximately 330 players each year. The NFL Combine, is a process where the most notable eligible college players every year are selected by the NFL teams and the scouts to perform in front of all the teams at one time, to gather such information such as physical indicators and grade performance drills. This is done to assist these teams in their drafts selection process. It takes place approximately two weeks after the Super Bowl in Indianapolis, Ind. (mid-country), and lasts three days.

It is contemplated that fans would have access to publications and web sites to view information and even watch clips of eligible pool players.

It is contemplated that fan participation can be in conjunction with a show. In a preferred embodiment, this 8^{th} round draft (fan draft), is staged approximately three hours after the last formal draft pick has been completed. This timing allows the fans of each team to compose a list from the eligible pool of players he thinks his/her team should have drafted. It is further contemplated that this show could be an introduction to a series of shows following the fan selected draft choices. The format could lead to further show “spin-off” programming as each of the 32 players can be followed in their endeavor for success. For example, the NFL Network had a show entitled “Hard Knocks” that was successful in obtaining viewership by following NFL training camp of a specific team. The envisioned program could comprise 32 different “reality” stories as players struggle to make a NFL roster and financial success.

The tally is done through the direction of the sponsor. The selection sequence is in the same order as that of the Official NFL Draft. Trading is not allowed. That is, each team must select the 8^{th} round pick chosen by fans. If the fan choice for a given team has already been selected, then the team must select the second choice and so on.

In one embodiment, fans are only allowed to vote within their area code or zip code to prevent fraudulent picks.

It is contemplated that a sponsor would be sought. The sponsor would be required to make a standard sponsorship marketing purchase to obtain entitled rights to the broadcast and surrounding properties. The purchase price could be determined by production costs. The price could also be determined by which network would “buy” the broadcast. The sponsor could be provided for example from the network or the NFL. Monies received from sponsors would be broken down such as the following: the retired players funding 33.3%, television show costs 29%, 8th round draft choices, players costs 19%, team and league charitable contributions 7.9%, production costs 10.8%. Thus as contemplated, a significant part of programming is used to assist the former retired NFL players.

The eighth round players are actually drafted by the teams. Expenses related to the draft are covered. Such expenses could include but are not limited to a bonus for each player drafted in the 8th round (as of 2008 the maximum UDFA Bonus is $27,000 or less, a bonus of at least $50,000 for 8^{th} round picks under this program is envisioned), players' transportation and expenses at NFL camp, and equipment costs. Funding is obtained through sponsors, commissions from cell phone call-ins, and “Spin-Off” programming. Profits can be set aside as a fund for the well-being of retired NFL football players not currently under the latest NFL CBA (Collective Bargaining Agreement). Preferably, the funds are a designated part of the sponsorship. For example, these funds are set up as an interest bearing Credit Union and are insured.

It is further contemplated that retired players' needs are determined by a committee of their peers, and that payback of any debt service can be waived pending specific need. It is also contemplated that any and all interest is put back into the fund.

Teams are under no obligation to keep or sign the 8^{th} round selected players if they do not make the roster. The 8^{th} rounder has an equal chance as of any UDFA or formally drafted player to make an NFL roster. A hidden “Star” player might be produced for that team. It has been said the draft is not an exact science.

The Official NFL Draft contains all of the elements of successful shows such as Survivor, American Idol and Deal or No Deal. The Official NFL Draft had TV ratings in 2006 of 5.2—twice that of the Stanley Cup Finals. These ratings surpass the MLB playoffs and World Series Games as well. Further, the draft is 17 hours of straight coverage not just three or four. Although it is not a sporting event, it has all of the intrigue and drama for many fans. In fact, almost 37 million people watched the 2006 draft.

The draft is a complex version of high's and lows of the NFL fan on how the future of their team was constructed or destructed; see, for example, Miami in 2006-2007. The event is very emotional for the fan. It brings new hope. The slate is clean and “wait until next year” is a reality.

In accordance with an embodiment of the present invention, the system and method disclosed herein provides a means to give fans an opportunity to have a say and participate in the NFL draft for their respective team. For example, a show may be produced by/for and/or shown on a major network or cable channel. The contemplated show is a complementary and supplementary attraction for the present NFL draft. The show generates interest and revenue in an unprecedented manner by involving the fans, the NFL teams, their respective charitable entities and the former players and coaches of the league.

The show would have a national contest with every NFL team allowing one or more fans from each team to participate in the 8^{th} round draft pick. On the day following the Official NFL Draft, all of the teams are in a feeding frenzy to call up and solicit UDFAs. Some of these players are rated very highly, some may have had lingering injuries, but there are usually two to five UDFAs that make NFL rosters every year when famous veterans and high draft choices are set adrift. The UDFA sculpts the team.

In accordance with an embodiment of the present invention, prior to the draft, for example, sometime starting in the summer or fall, one or more fans chose potential UDFA players that their team might select in next year's draft. The list will intensify the weekend before the draft as the previous college season unfolds and produces stats and scenarios. However, in order to qualify to be able to vote, each fan must first purchase or agree to respond to a “sponsor” and, then, they can cast their vote. For example, but not limited to, the sponsor could be a beer company, where they send in a number on the label of a bottle or can, or a publisher from whom the fan agrees to take sample magazine packages that will not cost them.

In accordance with an embodiment of the present invention, part of the sponsor funding goes to the network for production costs or media expenses to produce the show. The sponsor benefits through exposure, enhanced good-will, and/or the opportunity to sell more products, give away more samples and/or retain new customer names.

In accordance with an embodiment of the present invention, the show, the NFL and, ideally, every NFL team would agree to the concept, and a percentage of the profits from each team sponsorship would: 1/ used to alleviate financial difficulties faced by former NFL players and coaches, who are not qualified for benefits under today's NFL retirement structures; 2/ permit teams to support self-selected charities; and/or 3/ contribute to league-wide charities. It is contemplated that such philanthropy would motivate further fan participation, which, in turn, would increase revenues for the sponsors and the amount of money the sponsors could contribute. Thus, a philanthropic funding mechanism is disclosed herein.

In accordance with an embodiment of the present invention, each of the voting fans would “purchase” a right to make a choice for their team, as described above. At the end of the Official NFL Draft (beginning Sunday evening), each team's final fan vote would be counted and at least the highest ranking UDFA player would be bid on by that team, as the teams are bidding upon others too. If a team's highest ranked fan UDFA player is taken by another team, then the team bids on the next highest ranking player based on the fan-voted list. This order is based on the previous season's win/loss record, with the worst team drafting first.

In accordance with an embodiment of the present invention, each of the teams is obligated to bid on and sign only one player from the fan-voted list. However, there is no obligation on the team to keep the player on the team, if the player does not work out for a roster spot.

In general, the “Signing Bonus” for an UDFA is as low as $10,000, although it can be as high as $25,000. In accordance with an embodiment of the present invention, each team would be allocated at least $50,000 for the UDFA player signed and at least $20,000 to the team to develop, feed, house, train and teach the UDFA player in that team's pre-season training regimen. As a result, UDFA players would want to be the show pick. Thus, one player that had not been formally drafted is chosen as an 8^{th} round draft choice. Each team selects one player in this matter. The order of selection is the selection number of that year's draft sequence. That is, the worst team of the previous year picks first and the super bowl winner picks last.

The show would obtain the right to use like and likeness for every UDFA player that is signed under the show name and be able to do features or a weekly show about the progress of each UDFA player that the fans of that team have chosen.

In accordance with an optional embodiment of the present invention, if a player is signed to the final 53 player roster prior to game one of the 2008 season, the participating fans of that particular team or teams, are put into a drawing. The winner or winners of the drawing may, for example, get free tickets, transportation and lodging to the 2008 Super Bowl care of the show. The show may obtain the rights to use the like and likeness from those participating fans and can do a follow up show on the Super Bowl trip. It is contemplated that each team has one winner.

Finally, the show can sell the broadcast pieces to a network such as NFL, ESPN, Fox, or the like. This would be a major revenue stream.

In accordance with an alternative embodiment of the present invention, the assistance of the NFL and a change in format are needed. In this embodiment there would be a single 8^{th} draft choice by each team on behalf of the retired players and through the efforts of the show. Each of the participating teams would be presented with their team's voted picks list after the last choice in round seven of the draft. The votes are tabulated for an available player who is fan chosen and the “Fan Draft” begins.

After the player with the most fan votes has been selected by a team, the vote tabulation for that player may be made available on screen and on line to verify that the pick was accomplished and/or if the player with the most fan votes for a team was already chosen by another team. If the player has already been chosen by another team, the next available pick of a UDFA player shall be chosen and shown. The order in which the teams will select their UDFA players will be based on how the NFL lines them up for that particular season by their previous seasons records.

In general, the UDFA player will be chosen by each NFL team based on the survey of that team's fans only, and the NFL team cannot influence the vote of the fans (i.e., We need a Wide Receiver so vote for that choice). This includes agents, scouts, draftable players or management will not be permitted to vote.

In accordance with one or more embodiments of the present invention, the UDFA pick may not be traded between teams like a normal NFL allocated draft pick can be. In general, a specified amount of time may be allotted for each pick.

In accordance with one or more embodiments of the present invention, the team is not restricted by CAP rules for this pick. Nor will the NFL team have to compensate the UDFA player unless the team signs the player to a long-term deal. Instead, the show will pay each player a pre-designated signing bonus of such as $50,000 or more and each team will be allotted a pre-designated amount such as $20,000 or more by the show as a “development fee” for each pick.

In accordance with one or more embodiments of the present invention, the NFL team is under no obligation to sign the UDFA draft pick to a long-term contract, although all bonus and development monies are non-refundable. However, each selected UDFA player must make their team as in any other drafted player scenario.

In accordance with one or more embodiments of the present invention, a show/NFL committee may be formed for a ruling on a player picked by the fans if the player must be must be disqualified for legal, health or other player status changes.

In general, like and likeness of each team and the team's selected UDFA player, shall be made available for the exclusive use of the show.

In accordance with one or more embodiments of the present invention, the contest may be run between the team's fans to see which pick gets signed long term.

A contemplated goal of the examples set forth herein is to provide retired players with a financial outlet that, although not a pension as per se, can be used for banking procedures, emergencies or like similar issues and can be relied upon that the present NFLPA take for granted in their CBA. It is a fund specially designed for them as the forefathers of the NFL game. It can be handled by a financial fund that would invest the dollars such as AIG or HANCOCK etc. The fund would earn interest, and could invest to gain more interest. Although AIG or various insurance companies or retirement fund corporations would make perfect sense to be the “sponsor”, other approved companies such as TIME WARNER, JOHNNY ROCKETS, COORS, CITGO etc. may be contacted.

In accordance with one or more embodiments of the present invention, this could alternatively be accomplished through creation of a Credit Union with the shares being divided among all those legitimate NFL retirees that have served at least a minimum level of playing time in the NFL. Injured players with less time served may also be considered.

In accordance with one or more embodiments of the present invention, the possibility of “spin-off” programming is also contemplated. For example, “fan chosen” players could have their own show on the trials and tribulations of not being drafted by a team but being drafted by fans and how they proceed though training camps to reach their goals.

In accordance with one or more embodiments of the present invention, because there are fans out there by the millions who are emotionally involved in the decisions that their NFL team makes and spend billions of dollars on tickets, parking, concessions, souvenirs and apparel to show loyalty and esprit-decor, if the teams or the NFL can see there is another opportunity that creates further interest in their sport, it is a win. The fan also has an outlet to express themselves in a literal matter to the team they support.

There has thus been outlined, rather broadly, the more important features of the invention in order that the detailed description thereof that follows may be better understood, and in order that the present contribution to the art may be better appreciated. There are, of course, additional features of the invention that will be described further hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced or carried out in various ways. Also, it is to be understood that the phraseology and terminology employed herein are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that equivalent constructions insofar as they do not depart from the spirit and scope of the present invention, are included in the present invention.

What is claimed is:

1. A process of fan participation comprising:
selecting a voting structure;
informing at least one fan of said voting structure;
providing for fan participation, wherein said fan participation results in at least one vote(s);
tallying said vote(s) by a pre-determined tallying means.

2. The process of claim 1, wherein each at least one fan casts at least one vote and wherein each said vote is a choice for an NFL draft pick.

3. The process of claim 2, wherein each said choice is selected from an eligible pool and wherein said eligible pool is at least one of UDFA Group 2 or players invited to NFL
Combine.

4. The process of claim 1, wherein the voting said voting structure is part of a reality show format.

5. The process of claim 2, wherein said voting structure provides revenue and wherein at least a portion of said revenue is invested in a fund for retired NFL players.

6. The process of claim 4, wherein said reality show provides revenue and wherein at least a portion of said revenue is invested in a fund for retired NFL players.

7. A method of funding a fund for retired players comprising:
selecting a show format said format comprising a method of voting;
informing at least one fan of said voting method;
providing for fan participation, wherein said fan participation results in at least one vote(s);
tallying said vote(s) by a pre-determined tallying means.

8. The method of claim 7, wherein each at least one fan casts at least one vote and wherein each said vote is a choice for an NFL draft pick.

9. The method of claim 8, wherein each said choice is selected from an eligible pool and wherein said eligible pool is at least one of UDFA Group 2 or players invited to NFL Combine.

10. The method of claim 7, wherein the show format is a reality show format.

11. The method of claim 7, wherein said voting method provides revenue and wherein at least a portion of said revenue is invested in a fund for retired NFL players.

12. The method of claim 10, wherein said reality show provides revenue and wherein at least a portion of said revenue is invested in a fund for retired NFL players.
